(19) United States
(12) Patent Application Publication
(10) Pub. No.: US 2021/0267715 A1
(43) Pub. Date: Sep. 2, 2021

(54) INJECTION SYSTEMS IN THE RADICULAR CANAL SYSTEM AND USE THEREOF

(71) Applicant: ANGELUS INDUSTRIA DE PRODUTOS ODONTOLOGICOS S/A, LONDRINA - PR (BR)

(72) Inventor: ROBERTO QUEIRÓZ MARTINS ALCÂNTARA, LONDRINA - PR (BR)

(21) Appl. No.: 17/255,177

(22) PCT Filed: Aug. 10, 2018
(86) PCT No.: PCT/BR2018/050285

§ 371 Date: Dec. 22, 2020

(30) Foreign Application Priority Data
Jun. 25, 2018 (BR) 10 2018 013080 3

(51) Int. Cl. A61C 5/50

(52) U.S. Cl. CPC A61C 5/50; A61C 19/041

(57) ABSTRACT

A system for injection of endodontic cement into the radicular canal system comprising a closed-end cannula and at least one side orifice. Also disclosed are a system comprising a sleeve to be positioned between the cannula and the tooth, for injection of intra-radicular material, obliterating the aperture of the dental canal, a system comprising a moldable tip for a closed-end intra-radicular material injection cannula, and the use of the injection systems for the injection of endodontic cement.

### FIELD OF THE INVENTION

The present invention pertains to the field of dentistry, more specifically, to endodontic cement injection systems in the radicular canal system and use thereof.

### BACKGROUND OF THE INVENTION

Endodontic canal treatment techniques commonly involve processes of removal of diseased pulp tissue, mechanical and chemical cleaning of the canal with limes and irrigating agents, removal of bacteria and contaminated organic and inorganic content from the interior of the canal and its walls and, finally, filling specific materials such as gutta-percha and endodontic cement.

In order to fill the canal with gutta-percha and endodontic cement, the endodontic cement is usually applied inside the canal, followed by filling with gutta-percha. Optionally, the cones of gutta-percha are covered with endodontic cement and later inserted in the canal, and the filling techniques may involve, for example, the use of single cone, lateral condensation, Tagger's Hybrid technique, Buchanan's technique or even injection of heated gutta-percha.

Examples of systems used for filling the dental canal may be seen, for example, in publications such EP 0078258 (SOLAR ENERGY TECHNOLOGY, INC.); EP 1006923 (LIGHTSPEED TECHNOLOGY, INC.); EP 1951144 (COLTENE WHALEDENT GMBH & CO KG), among others.

Technical problems that exist in traditional filling techniques include the need to apply high pressure so that the cement conforms to the shape of the lumen of the main canal and penetrates the whole radicular canal system formed by main canal, collateral canal, lateral canal, secondary canal, accessory canal, interconduct, recurrent canal, reticular canal and apical delta, without mentioning the risk of cement to leak beyond the main canal (apical foramen) and to lodge in the periapical tissue outside the root behaving like a foreign body by not being reabsorbed by the organism. In addition, however, much pressure is applied to the cement, it may simply leak out of the upper canal aperture rather than fill the radicular canals system, wherein the absence of filling may cause bacterial growth and, as a result, undesirable effects such as inflammation, infection, and reabsorption of the bone surrounding the tooth.

The present invention aims to solve the problems observed in the prior art by providing a system for injecting endodontic cement into the radicular canal system as well as its production process.

### SUMMARY OF THE INVENTION

To solve the problems described above, the present invention will provide significant differentials regarding the current systems for injecting endodontic cement into the radicular system. In a first main embodiment, the object of the present invention is to provide a system for injecting endodontic cement into the radicular canal system comprising a closed-end cannula and at least one side orifice. In a second main embodiment, the object of the present invention is to provide a system comprising a sleeve to be positioned between the cannula and the tooth, for injecting intra-radicular material, obliterating the aperture of the dental canal. In a third embodiment, the object the present invention is to provide a system comprising a moldable tip for a closed-end intra-radicular material injection cannula. Further, the object of the present invention is to provide the use of said injection system for injecting endodontic cement.

### BRIEF DESCRIPTION OF THE FIGURES

The structure and operation of the present invention, together with additional differentials thereof, may be better understood regarding the accompanying drawings and the following description:

FIG. 1 illustrates the cannula of one of the main embodiments of the present invention, its closed-ends, and side orifices.

FIG. 2A illustrates a healthy tooth with prominence for its canal system.

FIG. 2B illustrates a canal where the cleaning with limes was performed, evidencing the irregular shape of the main conduit and the difficulty of cleaning and filling the secondary canals.

FIG. 2C illustrates the introduction of the cement injection cannula positioned within the canal after cleaning and biomechanical preparation thereof with the cannula positioned to inject the endodontic cement through the side orifices and the termination of the cannula sealing the apex of the root.

FIG. 2D illustrates, with directional arrows, the direction taken by the endodontic cement when it is injected through the cannula.

FIG. 3 illustrates examples of cross-sectional shapes of the cannula.

FIG. 4 illustrates examples of closed-end shapes of the cannula.

FIG. 5 illustrates how to measure (diameter) the end of the cannula, which may have standard diameters to those used in endodontic limes (0.25 to 1.40 mm) in the case of cylindrically shaped cannula.

FIG. 6 illustrates examples of side orifices shapes of the cannula.

FIG. 7 illustrates an example of distance or depth marking in the cannula body.

FIGS. 8A-8E illustrate examples of sleeves of another main embodiment of the present invention: with central passing through recess (8A); wherein the central recess terminates near the distal portion of the sleeve (8B); wherein the central recess extends horizontally to the side of the sleeve, in tape format, creating a tear on the side along the long axis of the sleeve (8C); wherein the sleeve comprises a central portion of rigid material (inner cone around the central recess) and an outer portion of more flexible or compressible material of the present invention (outer cone) (8D); wherein the central recess terminates near the distal portion of the sleeve (8E).

FIG. 9 illustrates a system concomitantly comprising the cannula containing a closed-end according to one of the embodiments of the present invention and a sleeve according to another embodiment of the present invention, inserted into the dental canal.

FIG. 10 illustrates an alternative embodiment, wherein the lower portion of the length of the cannula is replaced by a rod.

FIG. 11 illustrates another principal embodiment of the present invention, wherein the cannula has a tip of moldable material.

FIG. 12 illustrates the optional system comprised by the present invention, wherein the cannula is connected to a simple body auxiliary compression system through a dome.

FIG. 13 illustrates another optional system comprised by the present invention, wherein the cannula is connected to an auxiliary dual body compression system through a dome, which additionally contains a system that promotes mixing of endodontic materials at the time of injection.

### DETAILED DESCRIPTION OF THE INVENTION

According to a first principal embodiment, the present invention consists of a system for injecting endodontic cement into the radicular canal system comprising: a cannula (1) with a closed-end (1-D) and at least one side orifice (2).

According to a second main embodiment, the present invention consists of a system for injecting intra-radicular material comprising a sleeve (3), containing a central recess (8) to be positioned between a cannula (1) and the tooth, for injecting intra-radicular material, obliterating the aperture of the dental canal.

According to a third main embodiment, the present invention consists of a system for injecting intra-radicular material comprising a moldable tip (6) for a closed-end (1-D) intra-radicular material injection cannula (1).

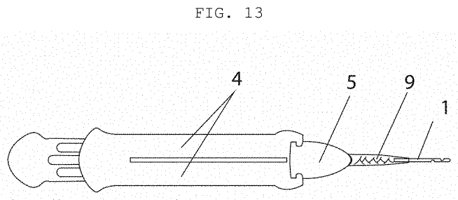

The endodontic cement injection system of the present invention further comprises an auxiliary compression system (4), wherein the single or double auxiliary compression system (4) can be coupled to the cannula (1) through a dome (5), as shown in FIGS. 12 and 13. A mixer of the materials (9) is present for the double system.

According to the present invention, the auxiliary compression system (4) must be understood as a device which transfers a fluid material under pressure to the cannula of the present system.

Examples of auxiliary compression system (4) may be plunger syringes, capsule guns, compressible tubes, or mechanical or pneumatic pumping systems.

According to the present invention, the dome (5) must be understood as the connection positioned on the upper portion of the cannula (1) to connect it to the auxiliary compression system (4). According to the present invention, the endodontic cement must be understood as the dental material for application and deposition in the endodontic canal, with the purpose of filling, adhesion and disinfection, for example: filling cements (temporary and definitive), adhesives cements, resin cements and ionometric cements. Just as an example, some brands of endodontic cement currently used are EndoSequence—Brasseler/USA, Metapaste-Temporary Root Canal Filling Material— MetaBiomed/South Korea, BIO-C Sealer—Angelus/Brazil, Dual Resin Cement Relyx U200—3M ESPE/USA, Glass Ionomer Cement Meron-Voco/Germany.

According to the present invention, intra-radicular material must be understood as any dental material for application to the dental canal, for example, for purposes of sealing, disinfecting, cleaning, drying, visualizing, contrasting, etc.

Regarding the physical characteristics of the endodontic cement, it is interesting to have, at the same time, a good penetration rate in the radicular canal system and to avoid excessive flow or drainage, for example, when the cannula is withdrawn from the main canal. In this context, according to an optional aspect, the viscosity (η) of the endodontic cement may be, for example, in the range of 4 to 7 Pa·s for a shear rate (\dot{γ}) of 60, 80 and 100 s-1, and a thixotropy (T) between 1 and 10 (KPa/s) for the shear cycle rate (\dot{γ}) from 0 to 100 s-1.

According to the present invention, the radicular canal system must be understood as the dental system formed by the main canal, collateral canal, lateral canal, secondary canal, accessory canal, interconduct, recurrent canal, reticular canal and apical delta.

According to the present invention, a cannula (1) must be understood as a tubular element for guiding the endodontic material into the radicular canal system.

The cross-section of the said cannula (1) can be triangular, square, pentagonal, hexagonal, octagonal, oval or round, with or without internal or external grooves.

Furthermore, the cannula (1) may have a cylindrical or conical shape with variations in diameter along its length. For example, it may have a conical shape, similar to the shape of commercial endodontic limes (0.25 to 1.40 mm). When cylindrical it can have the same standardized diameter of the tips of the endodontic limes throughout its length (0.25 to 1.40 mm).

The length of the cannula (1) may be in the range of 10 to 42 mm, preferably 17 mm to 31 mm, according to the length of endodontic limes.

The cannula (1) may also have distance or depth markings, for example, like a ruler, with marks, to indicate the depth with which it was inserted into the dental canal.

The cannula can have standardized colors like those used in the endodontic limes that define its diameter, facilitating its identification by the professional.

Regarding the material, the cannula (1) may be produced from various rigid or flexible materials including: metal, polymer, elastomer, association thereof or polymer-containing composite material and inorganic fibers selected from the group consisting of kevlar, glass, carbon or mixtures thereof, being interesting metal and polymer options.

In an alternative embodiment, the cannula (1) may be made of gutta-percha or other biocompatible material which may be left as a filler material in the dental canal without the need for removal part of the cannula after injection of the endodontic cement.

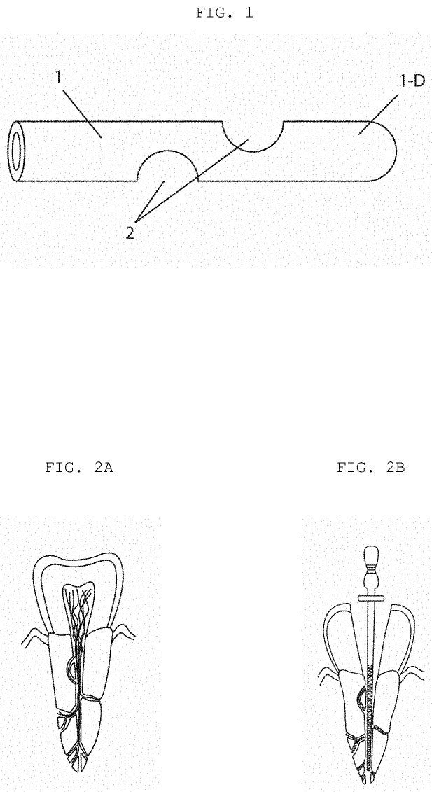

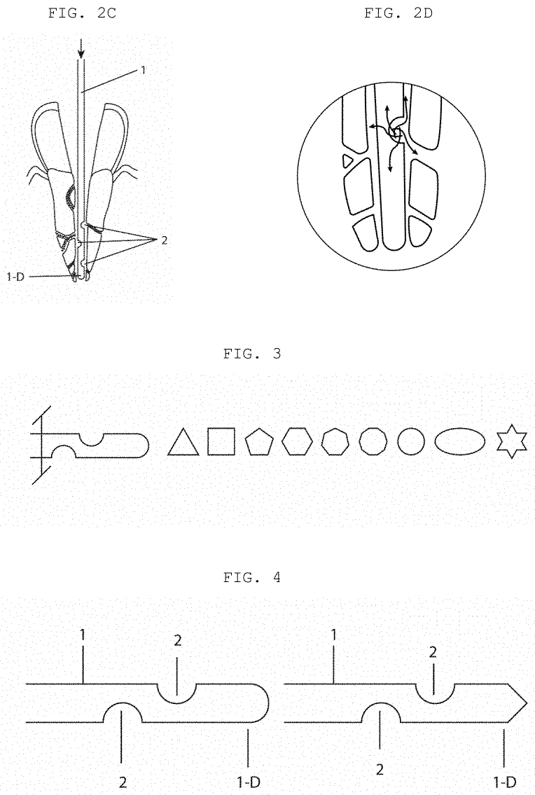

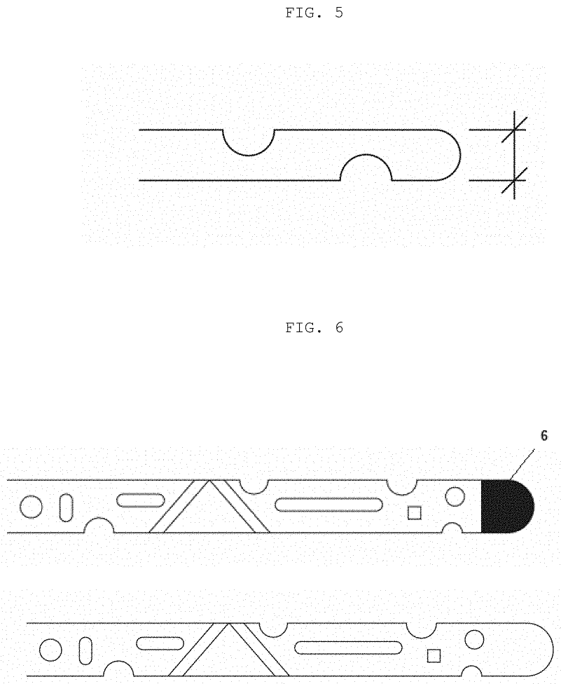

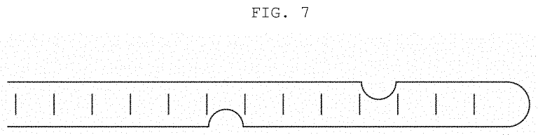

According to the present invention, the end (1-D) of the cannula (1) must be understood as the portion of the cannula which will be inserted deeper into the dental canal, as shown in FIG. 2C.

The end (1-D) of the cannula (1) may have a circular or oval shape, as shown in FIG. 4. In addition, the end (1-D) of the cannula may have a diameter selected from 0.25 mm to 1.4 mm, standardized with the final diameters of the commercial endodontic limes.

According to the present invention, the side aperture (2) must be understood as the aperture in the wall of the cannula (1) which allows the entrance of dental cement into the radicular canal system, as shown in FIG. 1, wherein the cannula (1) can have only one or multiple side orifices (2).

Said side orifice (2) may have a shape selected from one or more of the group formed by: hole, screen, longitudinal cut, transverse cut, oblique cut or spiral cut, preferably a hole, as shown by the FIG. 6.

In addition, the one or more side orifice (2) may be constructed or positioned to direct the endodontic cement in multiple directions regarding the cross-section of the cannula (1) and/or at different angles relative to the longitudinal axis of the cannula (1), as shown in FIG. 2D.

According to the present invention, the sleeve (3) must be understood as an element to be positioned in the cannula (1), functioning as a plug in the aperture of the canal. In an optional construction, the sleeve (3) can be slid longitudinally into the cannula or further molded around the cannula, filling the aperture of the dental canal.

According to the present invention, the sleeve (3) can be made of compressible and moldable materials at the aperture of the dental canal, such as, but not limited to: polymers, elastomers, silicones or combinations thereof. An interesting option may be, for example, the use of silicone, with hardness between 30 and 90 Shore A.

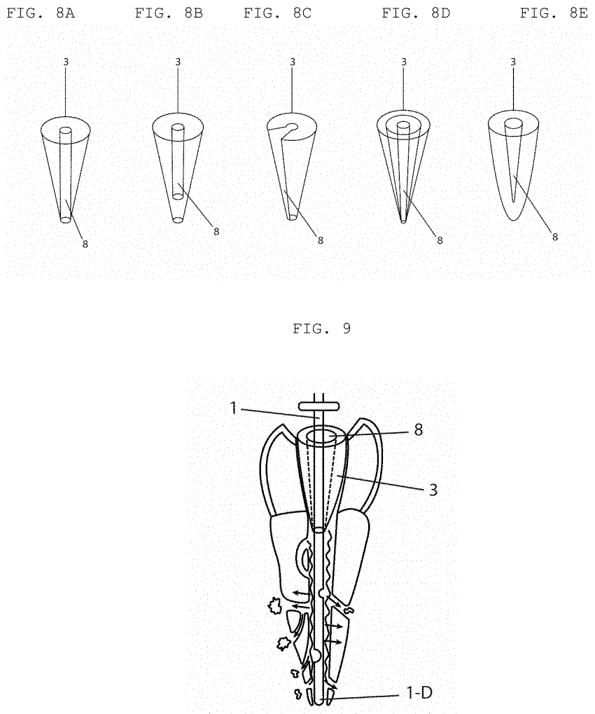

In addition, the sleeve (3) of the present invention may have various shapes, such as cylindrical, conical or ogival with a central recess (8), as shown in FIGS. 8A to 8E.

In the sleeve (3) of the present invention, the central recess (8) may pass through, i.e. the central recess (8) leads from the upper end to the distal end of the sleeve, as shown in FIG. 8, or the central recess (8) of the sleeve may extend from the upper end of the sleeve and be terminated next to the distal end thereof so that the distal portion of the sleeve may be perforated at the time of use, as shown in FIGS. 8B and 8E.

Furthermore, the central recess (8) of the sleeve (3) of the present invention may extend horizontally to the side of the sleeve, in a tape format, creating a tear on the side along the long axis of the sleeve, and may also pass through or be with close finishing the end, as shown in FIG. 8C.

In an alternative embodiment, the sleeve (3) may be produced with rigid material in its central portion and may be malleable in its outer portion, for example using a rigid polymer, externally coated with an elastomer, as shown in FIG. 8D.

In addition, the central recess in the sleeve may be moldable to the shape of the cannula so as to seal the space between the cannula and the sleeve, and the outer portion of the sleeve may be moldable to the shape of the aperture of the orifice in the dental canal.

The sleeve (3) of the present invention may have different lengths. Interesting options may vary from 3.0 to 8.0 millimeters, more specifically, about 5 millimeters.

According to the present invention, the sleeve (3) can have different diameters. In the case of sleeves of conical or oval shape, it may be of interest the diameter at the top of 1.0 to 5.0 millimeters, more specifically about 3.0 millimeters and diameter at the bottom, of 0.3 to 1.0 millimeter, more specifically about 0.5 millimeters.

As illustrated in FIG. 11, in an alternative embodiment, the cannula may have a tip (6) forming its end. In interesting optional embodiments, the tip (6) may be made of a material other than the material of the cannula, preferably more flexible and/or compressible. The tip (6) can have various lengths and diameters, for example, length from 0.3 to 2.0 mm and diameters selected between 0.25 mm 2 mm, standardized with final diameters of commercial endodontic limes.

Furthermore, said tip (6) may be made of compressible and moldable materials to the distal portion of the dental canal, such as, but not limited to: polymers, elastomers, silicones, or combinations thereof. An interesting option may be, for example, the use of moldable and biocompatible materials, such as gutta-percha, which can be left in the dental canal.

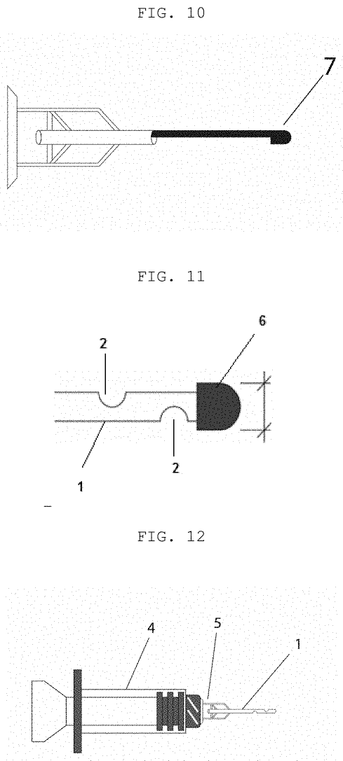

In addition, in an alternative embodiment, the lower portion of the cannula can be replaced by a rod (7), with endings in the standardized diameters to those of the endodontic limes, as shown in FIG. 10.

In an alternative embodiment, the cannula (1) may exhibit standard color marks in accordance with standards used for diameters of the distal portion of commercial endodontic limes: red (0.25 mm, 0.55 mm and 1.10 mm), blue (0.30 mm, 0.60 mm and 1.20 mm), green (0.35 mm, 0.70 mm and 1.30 mm), black (0.40 mm, 0.80 mm and 1, 40 mm), white (0.45 mm and 0.90 mm), yellow (0.50 mm and 1.00 mm).

Finally, the present invention comprises systems and the use of such injection systems described herein alone, together two by two, all three together, or in assemblies with other optional additional systems.

Thus, although only have been shown some embodiments of the present invention, it will be understood that various omissions, substitutions and changes in the system for endodontic material injection can be made by a person skilled in the art without departing from the spirit and scope of the present invention.

It is expressly provided that all combinations of elements performing the same function, in substantially the same manner to achieve the same results, are within the scope of the invention. Substitutions of elements from one embodiment to another are also fully intended and contemplated.

It is also must be understand that the drawings are not necessarily in scale, since they have only a conceptual nature. The intention is, therefore, to be limited, as indicated by the scope of the appended claims.

1. A system for injecting endodontic cement into a radicular canal system, comprising:
a closed-end cannula and at least one side orifice.

2. The system of claim 1 further comprising simple or double auxiliary compression systems coupled to the cannula through a dome.

3. The system of claim 1, wherein the at least one side orifice of the cannula is a hole, a screen, a longitudinal cut, a transverse cut, an oblique cut, or a spiral cut.

4. The system of claim 1, wherein a material of the cannula is selected from: metal, polymer, elastomer, a combination thereof, or a polymer-containing compound material and inorganic fibers selected from the group consisting of kevlar, glass, carbon, or mixtures thereof.

5. The system of claim 4, wherein the material of the cannula comprises metal or polymer.

6. The system of claim 4, wherein the material of the cannula is gutta-percha or other biocompatible material.

7. The system of claim 1, wherein the cannula has a length of between 10 mm and 42 mm.

8. The system of claim 1, wherein the cannula has distance or depth markings along its length.

9. The system of claim 1, wherein a shape of the cannula is cylindrical or conical with variations in diameter along its length.

10. The system of claim 1, wherein a cross-section of the cannula is triangular, square, pentagonal, hexagonal, octagonal, oval or round.

11. The system of claim 1, wherein a closed-end of the cannula has a circular or ogival shape.

12. The system of claim 2, wherein the auxiliary compression system is selected from: plunger syringes, pistols with capsules, compressible tubes, and mechanical or pneumatic pumping systems.

13. The system of claim 1, wherein the end of the cannula is formed by a tip.

14. A system for injection of intra-radicular material, comprising:
a sleeve comprising a central recess that is positioned between a cannula and a tooth, for injection of intra-radicular material, obliterating an aperture of a dental canal.

15. The system of claim 14, wherein a material of the sleeve is selected from: silicone, TPV, TPE, polypropylene, polyethylene, polycarbonate, or a combination of one or more of these materials.

16. The system of claim 14, wherein the sleeve is cylindrical, conical or ogival shaped.

17. The system of claim 14, wherein the central recess of the sleeve starts at an upper end of the sleeve and terminates at a distal end of the sleeve.

18. The system of claim 14, wherein the central recess of the sleeve starts at an upper end of the sleeve and terminates close to a distal end thereof.

19. The system of claim 14, wherein the central recess of the sleeve extends horizontally to a side of the sleeve, forming a tear on the side of a long axis of the sleeve, which may pass through or be close to the end.

20. The system of claim 14, wherein the central recess of the sleeve is molded to the shape of the cannula.

21. The system of claim 14, wherein an outer portion of the sleeve is molded to a shape of the orifice aperture in the dental canal.

22. The system of claim 14, wherein the sleeve has a length of 3.0 mm to 8.0 mm.

23. A system for injection of intra-radicular material, comprising a moldable tip for a closed-end intra-radicular material injection cannula.

24. The system of claim 23, wherein the material of the tip of the cannula is flexible, selected from polymers, elastomers, silicones, or mixtures thereof.

25. The system of claim 23, wherein the tip has a length of between 0.3 mm and 2 mm and a diameter of between 0.25 mm and 1.4 mm.

26. The system of claim 23, wherein the closed end of the cannula has a rod.

27. The system of claim 23, wherein the system is configured to inject endodontic cement.

28. The system of claim 27, wherein a viscosity of the endodontic cement is in the range of 4 to 7 Pa·s for a shear rate of between 60 and 100 sec-1, and a thixotropy of between 1 and 10 (KPa/s) fora cycle of shear rate of between 0 and 100 s-1.
